(19) United States
(12) Patent Application Publication
(10) Pub. No.: US 2002/0126090 A1
(43) Pub. Date: Sep. 12, 2002

(54) Navigating and selecting a portion of a screen by utilizing a state of an object as viewed by a camera

(75) Inventors: Scott Kirkpatrick, Jerusalem (IL); Frederic C. Kjeldsen, Poughkeepsie, NY (US); Robert B. Mahaffey, Austin, TX (US); Richard S. Schwerdtfeger, Round Rock, TX (US); Lawrence F. Weiss, Round Rock, TX (US)

Correspondence Address: Marilyn, S. Dawkins, International Business Machines Corporation, Intellectual Property Law Department, 11400 Burnet Road, Internal Zip 4054, Austin, TX, 78758, US

(73) Assignee: International Business Machines Corporation

(21) Appl. No.: 09/764,627

(22) Filed: Jan. 18, 2001

(51) Int. Cl. G09G 5/08

(52) U.S. Cl. 345/158

(57) ABSTRACT

A computer system is described including a camera, a display device (e.g., a display monitor) having a display screen, and a processing system coupled to the camera and the display device. The camera produces image signals representing one or more images of an object under the control of a user. The processing system receives the image signals, and uses the image signals to determine a state of the object. The state of the object may be, for example, a position of the object, an orientation of the object, or motion of the object. Dependent upon the state of the object, the processing system controls cursor movement and selection of a selectable item at a current cursor location. The object may be a body part of the user, such as a face, a hand, or a foot. The object may also be a prominent feature of a body part, such as a nose, a corner of a mouth, a corner of an eye, a finger, a knuckle, or a toe. The object may also be an object held by, attached to, or worn by the user. The object may be selected by the user or selected automatically by the processing system. Multiple images may be chronologically ordered with respect to one another.

### CROSS REFERENCE TO RELATED APPLICATIONS

SYSTEM AND METHOD FOR SCROLLING WITHIN A DISPLAYED ACTIVE WINDOW DEPENDENT UPON A STATE OF AN OBJECT VIEWED BY A CAMERA”, Serial Number (Internal docket number AUS920000015US1), filed Nov. 2, 2000, and commonly assigned, is hereby incorporated by reference.

### BACKGROUND OF THE INVENTION

1. Field of the Invention

This invention relates to navigating a computer display screen through a cursor controlled pointing device and enabling an activation of a portion of the screen at the cursor location; and more specifically to a system, method and program for enabling navigation and activation depending upon a state of an object as viewed by a camera.

2. Description of the Related Art

Modern computer operating systems provide graphical user interfaces (GUIs) rather than text-based user interfaces. As opposed to requiring a user to memorize and enter standard commands via a keyboard, a typical GUI allows a user to use a pointing device (e.g., a mouse) to navigate around the display screen and to “point” to a command listed in a menu. To navigate around the display screen, a conventional pointing device may be used such as a mouse, trackball, IBM Track-Point™, joystick, touchpad, or light pen. Pointing devices control the movement of a pointer or cursor on a display screen. To select a command, a momentary switch is pressed and released or “clicked.” Although the switch can be physically separate from the pointing device, a pointing device such as a mouse is frequently used which has the switch, referred to as a button, physically integrated within it.

The typical GUI allows the user to initiate execution of an application program by using the pointing device to position the pointer or cursor over a graphical representation (i.e., icon) of the application program and clicking the button of the pointing device. Elements of GUIs include windows, pull-down menus, buttons, icons, and scroll bars.

Such interaction with a GUI via a conventional pointing device presents a formidable challenge for users with impaired motor skills and/or physical abnormalities which prevent normal use of the pointing device. Known alternative pointing devices include head-mounted tracking devices which track the position of a user's head, and eye tracking devices which determine where a user's gaze is focused on a display screen. Typical head tracking devices require the user to attach a mechanical device or a reflective dot to a portion of the head. Requiring attachment of components to the user's head, such head tracking devices are undesirably obtrusive and conspicuous.

On the other hand, eye tracking devices typically do not require attachment of components to the head and are not conspicuous during use. However, eye tracking devices typically require that a user's eye remain focused within a confined area. The user must also maintain the head in a substantially fixed position, which requires constant mental concentration and physical strain, thus becoming increasingly tedious. The user must also have adequate control over head and postural movement, which is not possible with some afflictions. Further, eye tracking requires that the user be capable of, and exercise, precise control of eye movements.

It would thus be desirable to have a pointing device which is not obtrusive or conspicuous (i.e., does not require a component to be attached to the body) and does not require the body to remain in a substantially fixed position (i.e., allows a certain amount of normal body movement). Such a pointing device would be particularly useful to users with impaired motor skills and/or physical abnormalities which prevent normal use of a conventional pointing device.

### SUMMARY OF THE INVENTION

A system, method, and program are described which utilize a camera, a display device (e.g., a display monitor) having a display screen, and a processing system coupled to the camera and the display device. The camera produces image signals representing one or more images of an object under the control of a user. The processing system receives the image signals of a selected object, and uses the image signals to determine a state of the object. The state of the object may be, for example, a position of the object, an orientation of the object, or motion of the object. The processing system controls the movement of a cursor on the display screen and determines when the cursor location is being selected based upon the state of the object.

The object may be a body part of the user, such as a face, a hand, or a foot. The object may also be a prominent feature of a body part of the user, such as a nose, a corner of a mouth, a corner of an eye, a finger, a knuckle, or a toe. The object may also be an object held by, attached to, or worn by the user. Candidate objects include adornments such as jewelry (e.g., earrings), functional devices such as watches, and medical appliances such as braces. For example, the object may also be an adhesive sticker attached to the user. The object may also be a ball at one end of a stick, or any other object, held by the user such that the ball or other object is under the control of the user. The only limitations on the object are: (i) the object must be distinctive enough to be identifiable in images produced by the camera, and (ii) the user must be able to move the object through a sufficient range of motion. The object may be selected by the user during a calibration procedure. Alternately, the object may be selected automatically by the processing system. The system, however, does not require that the object must be any one specific object. That is, the system, method and program of the invention does not require that the object be any specific object. In other words, the object is selectable at a time of use by a user which includes any necessary calibration time.

The camera may, for example, produce images at substantially regular intervals. In this situation, the images may be ordered with respect to one another to form a chronological series. The images may include, for example, a first image and a second image of the object, where the first image precedes the second image in time. The first image may be an image acquired during the calibration procedure. Alternately, the first image may immediately precede the second image in the chronological series of images.

The image signals are received and analyzed by a processing system to determine the state of the object. The processing system controls the movement of the cursor on the display device in a direction and at a rate that is dependent upon the state of the object. For example, if in a particular image in the series of images the object has a component of movement within a plane parallel to a plane of the displayed data on a display device, then the cursor may be moved in the corresponding direction within the display as displayed on the display device at a rate dependent on the amount of movement of the object in the plane, as provided by a preferred embodiment of the invention. However, other embodiments may enable the configuration process to define the direction of cursor movement for any given direction of object movement. For example, movement of the object in space in a direction perpendicular to the display screen, may result in the cursor being moved within the plane of the display screen, etc. Regardless of the embodiment, the magnitude of movement of the cursor will correspond to the state (generally position, motion, rate of change, or orientation) of the object. The correspondence may be a one-to-one correspondence in some embodiments or it may be a configurable ratio or other, nonlinear, mapping function.

The parameters of the mapping function are determined during a configuration process in which the user may be prompted to move the object within a full range of motion, or the full range of motion may be otherwise inferred. The full range of motion of the object may be compared with a known full range of movement of a cursor on a given display connected to the processing system. The processing system determines the parameters of the mapping function, for example the ratio between an amount of movement of the object and the corresponding amount of movement of the cursor displayed on the display monitor. In other embodiments, the user can directly define the parameters of the mapping function. In addition, in some embodiments the relationship between the state of the object and the distance in which the cursor is moved takes into account an ignored range of movement of the object such as movement that may be caused by uncontrolled shaking of the object by a user.

More particularly, the object resides within a field of view of the camera, and the camera produces images of the object within image frames. An image of an object within an image frame is referred to herein as a “projection” of the object. In some embodiments, the state of the object is defined as a position, orientation, or motion of the object's projection or a reference point within the object's projection. Such states of the object are referred to herein as two dimensional (2D) states of the object. In other embodiments, the state of the object is defined as the position, orientation, or motion of the object with respect to other physical constructs or objects within the field of view of the camera and appearing within image frames. Such states of the object are referred to herein as three dimensional (3D) states of the object.

In several embodiments, the state of the object is determined by a vector associated with the position, orientation, or motion of the object. Once the vector is determined, certain attributes of the vector are translated into the direction and displacement of the cursor.

In one 2D embodiment, the 2D state of the object is a position of the object (i.e., a position of the object's projection) in the second image relative to a position of the object (i.e., a position of the object's projection) in the first image. A base position of the object (i.e., a base position of the object's projection) may be defined during a calibration procedure, and the 2D state of the object may be a position of the object (i.e., a position of the object's projection) relative to the base position of the object (i.e., the base position of the object's projection). A reference point may be selected within a boundary of the object during the calibration procedure, and the 2D state of the object may be a position of the reference point in the second image relative to a position of the reference point in the first image. A base position of the reference point may be defined during the calibration procedure, and the 2D state of the object may be a position of the reference point relative to the base position of the reference point.

Likewise, during calibration, a base position of the displayed cursor is defined such that a base position of the displayed cursor corresponds to the base position of the object or to the base position of the reference point. For example, the base position of the displayed cursor may be a predetermined position of the cursor, such as a corner of the display area, or the center of the display screen, or a current position of the cursor.

The position of the object (in terms of the position of the object's projection or in terms of a reference point selected within a boundary of the object) in the second image relative to the position of the object in a first image or base position is used to define a current position of the cursor relative to a previous position of the cursor. In a similar manner, the position of the object relative to a previous position of the object can be used to determine a distance of the object in a second image from the object in a first image. The object distance is then used to determine a distance of the cursor in a current position from a previous position of the cursor, thereby utilizing rate control to position the cursor. The cursor change in position may be a linear ratio of the object change in position, or may be any other predetermined or user determined mapping function.

In one scenario, the object is the user's face, the center of the face is a reference point, and the base position of the reference point is the location of the reference point when the user is looking at the center of the display screen.

In the above scenario, the 2D state of the face may include a direction of the reference point relative to the base position of the reference point or relative to the position of the reference point in the first image. Upon receiving an image from the camera, the processing system may determine the direction of the reference point relative to the base position of the reference point or relative to the position of the reference point in the first image, and provide the display data to the display device such that movement of the cursor is in a direction corresponding to the direction of the reference point relative to the base position of the reference point or relative to the position of the reference point in the first image.

In another 2D embodiment, the 2D state of the object is an orientation of the object relative to a base orientation of the object. The base orientation may be defined during a calibration procedure. As described above, the images may include the first image of the object which precedes the second image in time. In this situation, the 2D state of the object may be an orientation of the object in the second image relative to an orientation of the object in the first image. A reference point may be selected within a boundary of the object, and the 2D state of the object may be an orientation of the reference point in the second image relative to an orientation of the reference point in the first image.

The state of an object as defined by it's orientation may define the direction and magnitude of movement of the cursor. The changed state, as defined by its change in orientation, may also be processed to cause a selection at the current cursor location. For example, the orientation may include an angular rotation of the object. The direction of rotation my define a direction of cursor movement. A magnitude of the angular rotation may define a magnitude of cursor movement or some corresponding ratio thereof. Alternatively, the angular rotation my cause a selection to be made at the current cursor location.

In some 3D embodiments, the 3D state of the object is determined by a vector extending from a previous position of a reference point, determined using a first image, to a current position of the reference point determined using a second image. The first image precedes the second image in time. The reference point is selected within a boundary of the object (e.g., during the calibration operation). In some embodiments, the previous position of the reference point is a base position of the reference point. The vector extends from the previous position to the current position, and defines the 3D state of the object.

In the 3D embodiments, the state vectors may have components in each of three orthogonal directions. In general, any two of the three components may be all that is needed to control the cursor movement. For example, the vector may have a dₓ component in an x direction, a d_{y} component in a y direction, and a d_{z} component in a z direction. In this situation, the x, y, and z directions are orthogonal. The x and y directions may define an xy plane substantially parallel to the display screen of the display device, and the z direction may be substantially normal to the display screen of the display device. The processing system may be configured to determine the dₓ component of the vector, and to provide the display data to the display device such that movement of the cursor occurs in a direction corresponding to the dₓ component of the vector. Further, the processing system may be configured to determine the d_{y} component of the vector, and to provide the display data to the display device such that movement of the cursor occurs in a direction corresponding to the d_{y} component of the vector.

In some embodiments, the processing system may be configured to provide an indication such that a selection or “click” at a current cursor location is determined to be made dependent upon some minimal value of a d_{z} component of the vector. Again, some range of movement as indicated by the d_{z} component may be ignored in order to allow some amount of unintended movement of the object along the z-axis.

Furthermore, selection of data or a selection of an area of the displayed data or a selection of a graphical representation at the cursor location may be determined to have been made based upon a different state of the same object, or a change in state of a different object. For example, if there is a change in state of the same or different object along the z-axis, e.g., a change in position of the object along an axis perpendicular to the display screen, while the position of the object along each axis parallel to the display screen, i.e., the x and y axes, remains within the ignored range, then the processing system determines that a selection at the current cursor position has been made. Any change in state of a different object, i.e., any object other than the one being used to move the cursor, can trigger a determination that a selection has been made, also.

In other 3D embodiments, the 3D state of the object is a current orientation of the object relative to a previous orientation of the object. A reference orientation of the object is selected (e.g., during the calibration operation). A previous orientation of the reference orientation is determined using a first image. In some embodiments, the previous orientation of the reference orientation is a base orientation of the reference orientation. A current orientation of the reference orientation is determined using a second image, where the first image precedes the second image in time. An orientation of the current orientation relative to the previous orientation determines the state of the object.

For example, an angle θ may exist between the current orientation of the reference orientation and the previous orientation of the reference orientation in a substantially horizontal plane. In some embodiments, orthogonal x, y, and z directions are established such that the x and z directions define a substantially horizontal xz plane. The xz plane is substantially perpendicular to the display screen of the display device, and the angle θ exists in the xz plane. In addition, z and y directions define a substantially vertical zy plane. The zy plane is substantially perpendicular to the display screen of the display device, and the angle θ exists in the zy plane. The processing system may be configured to determine the angle θ, and to provide the display data to the display device such that movement of the cursor occurs in the x or y direction of the display screen corresponding to the angle θ in the xz or zy plane, respectively. The magnitude of the movement of the cursor corresponds in some predefined or configured relationship to the magnitude of the angle θ in the xz or zy plane. It should be noted that the direction of movement of the cursor, i.e., one of two opposite directions such as up or down from its previous position, or left or right from its previous position, depends upon a sign of angle θ.

### BRIEF DESCRIPTION OF THE DRAWINGS

For a more complete understanding of the present invention and the advantages thereof, reference should be made to the following Detailed Description taken in connection with the accompanying drawings in which:

FIG. 1 is a side elevation view of a user sitting in front of one embodiment of a computer system, wherein the computer system includes a housing coupled to a camera and a display monitor, and wherein the computer system controls the movement of a cursor displayed upon a display screen of the display monitor, and controls a selection or “click” at the cursor location, dependent upon image signals produced by the camera;

FIG. 2 is front view of the head and neck of the user of FIG. 1 illustrating a body part of the user and prominent features of the body part which may be tracked by a processing system of the computer system via imaging;

FIG. 3 is a block diagram of one embodiment of the housing of FIG. 1, wherein the housing houses a processing system coupled to the display monitor and the camera;

FIG. 4 is one embodiment of a first image of a hand and a portion of a forearm of the user of FIG. 1, wherein the hand is selected to control the movement of a cursor displayed on the display screen, and wherein a reference point defined within a boundary of the hand moves within a full range of motion associated with the hand, and wherein a state of the hand is defined by the position of the reference point relative to a defined base position of the reference point;

FIG. 5 is one embodiment of a second image of the hand and the portion of the forearm of the user of FIG. 4, wherein the second image is acquired subsequent to the first image of FIG. 4, and wherein the position of the reference point relative to the base position defines a vector, and wherein the state of the hand is defined by the vector;

FIG. 6 is a diagram of one embodiment of the full range of motion of FIGS. 4 and 5, wherein an ignored range of motion is established about the base position such that involuntary movements of the hand within the ignored range of motion are ignored (i.e., do not result in movement of the cursor);

FIG. 7a and 7b are diagrams illustrating displayed cursor movement distance “d” versus displacement “D”, where displacement “D” is the magnitude of the vector of FIG. 5, thereby illustrating one possible method of converting the magnitude of object movement to a magnitude of displayed cursor movement;

FIG. 8 is a diagram of one embodiment of a first image of a face, neck, and shoulders of a user, wherein the face is selected to control cursor movement, and wherein a center of the face is selected as a reference point, and wherein a position of the reference point when the user is looking at a center of the display screen of the display monitor is selected as a base position of the reference point, and wherein a state of the face is defined by the position of the reference point relative to the base position;

FIG. 9 s a diagram of one embodiment of a second image of the face, neck, and shoulders of the user of FIG. 1, wherein the second image is acquired subsequent to the first image of FIG. 8, and wherein the position of the reference point relative to the base position defines a vector, and wherein the state of the face is defined by the vector;

FIG. 10 is a diagram of one embodiment of a first image of a hand and a portion of a forearm of a user, wherein the hand is selected to control cursor movement, and wherein a reference point is selected within a boundary of the hand, and wherein a state of the hand is defined by the position of the reference point relative to a position of the reference point in a previous image (i.e., a previous position of the reference point);

FIG. 11A is a diagram of one embodiment of a second image of the hand and the portion of the forearm of the user of FIG. 10, wherein the second image is acquired subsequent to the first image of FIG. 10, and wherein a current position of the reference point relative to a previous position of the reference point defines a vector, and wherein the state of the hand is defined by the vector;

FIG. 11B is a diagram of an alternate embodiment of the second image of the hand and the portion of the forearm of the user of FIG. 10, wherein a second reference point is selected in addition to the first reference point, and wherein a first vector extends from the second reference point to the previous position of the first reference point, and wherein a second vector extends from the second reference point to the current position of the first reference point, and wherein the first and second vectors define a third vector, and wherein the third vector defines the state of the hand;

FIG. 12 is a diagram of one embodiment of a first image of a face, neck, and shoulders of a user, wherein the face is selected to control cursor movement, and wherein a reference orientation of the face is selected, and wherein an orientation of the reference orientation is selected as a base orientation of the reference orientation, and wherein a state of the face is defined by the orientation of the reference orientation relative to the base orientation; and

FIG. 13 is a diagram of one embodiment of a second image of the face, neck, and shoulders of the user of FIG. 12, wherein the second image is acquired subsequent to the first image of FIG. 12, and wherein an angle θ existing between the reference orientation and base orientation defines the state of the face;

FIG. 14 is a top plan view of a previous position and a current position of the user's head within a field of view of the camera of the computer system of FIG. 1, wherein a base position of a reference point is selected in the previous position of the user's head, and wherein a current position of the reference point relative to the base position defines a vector, and wherein the vector defines a state of the user's head;

FIG. 15A is a top plan view of a previous position and a current position of the user's head within a field of view of the camera of the computer system of FIG. 1, wherein a current position of a reference point relative to a previous position of the reference point defines a vector, and wherein the vector defines a state of the user's head;

FIG. 15B is a top plan view of a previous position and a current position of the user's head within a field of view of the camera of the computer system of FIG. 1, wherein a first reference point is selected within a boundary of the user's head, and wherein a second reference point is selected outside of the boundary of the user's head, and wherein a first vector extends from the second reference point to a previous position of the first reference point, and wherein a second vector extends from the second reference point to a current position of the first reference point, and wherein the first and second vectors define a third vector, and wherein the third vectors defines a state of the user's head; and

FIG. 16 is a top plan view of a previous position and a current position of the user's head within a field of view of the camera of the computer system of FIG. 1, wherein a reference orientation of the user's head is selected, and wherein an orientation of the reference orientation in the previous position of the user's head is selected as a base orientation of the reference orientation, and wherein a state of the user's head is defined by an orientation of the reference orientation in the current position of the user's head relative to the base orientation, and wherein the state of the user's head is dependent upon an angle between the reference orientation and the base orientation.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

In the following description, reference is made to the accompanying drawings which form a part hereof, and which illustrate several embodiments of the present invention. It is understood that other embodiments may be utilized and structural and operational changes may be made without departing from the scope of the present invention.

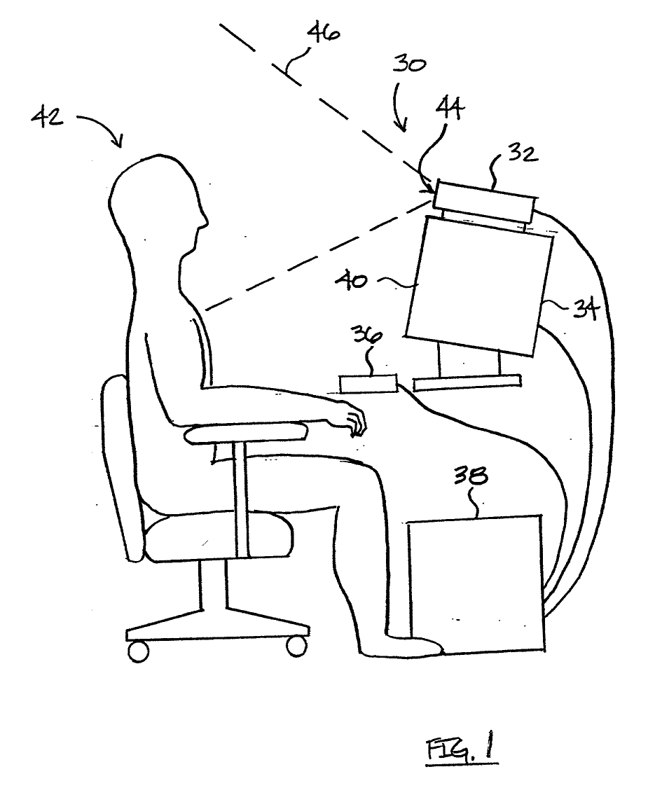

FIG. 1 is a side elevation view of a user 42 sitting in front of one embodiment of a computer system 30, wherein computer system 30 provides hands free user input via optical means for controlling the movement of a cursor displayed on a display monitor, and for controlling a selection of a selectable area at the cursor location. In the embodiment of FIG. 1, computer system 30 includes a camera 32, a display monitor 34, and an input device 36 coupled to a housing 38. Display monitor 34 includes a display screen 40 for displaying display data and a cursor.

As will be described in detail below, computer system 30 uses image signals produced by camera 32 to determine a “state” of a selected object appearing within an image produced by camera 32. The state of the selected object may be defined by a position of the selected object, an orientation of the selected object, and/or motion of the selected object. The selected object resides within a field of view of the camera, and the camera produces images of the object within image frames. Computer system 30 controls the movement of the cursor displayed upon display screen 40 of display monitor 34, including the positioning of the cursor, and any selection of an item at the cursor location, dependent upon the state of the selected object.

Camera 32 is positioned such that a light-gathering opening 44 of camera 32 is directed toward a selected object. The selected object resides within a field of view 46 of camera 32. In FIG. 1, opening 44 of camera 32 has been directed such that a head and neck of user 42 are within field of view 46 of camera 32. A lens may be positioned in front of opening 44 for focusing light entering opening 44. During operation, camera 32 converts light entering opening 44 from field of view 46 into electrical image signals. In doing so, camera 32 produces image signals representing images of all physical constructs and objects, including the selected object, within field of view 46.

The selected object is under the control of a user 42, and image information regarding the selected object is used to control the providing of display data to display monitor 34 such as the positioning of a cursor. The object may be, for example, a body part of user 42, such as a face, a hand, or a foot. The object may also be a prominent feature of a body part of user 42 such as the user's nose, a corner of the user's mouth, a corner of the user's eye, a finger, a knuckle, or a toe, etc.

The object may also be an object held by, attached to, or worn by the user. Candidate objects include adornments such as jewelry (e.g., earrings), functional devices such as watches, and medical appliances such as braces. For example, the object may also be an adhesive sticker attached to the user. The object may also be a ball or any other object held in the hand of a user, or a ball or other object at one end of a stick held by user 42 such that the object is under the control of user 42. The only limitations on the object are: (i) the object must be distinctive enough to be identifiable in images produced by camera 32, and (ii) user 42 must be able to move the object through a sufficient range of motion.

It should be noted, however, that the user is not limited to any specific object. The object may be selected by the user, or selected automatically by a processing system of computer system 30.

During one embodiment of a calibration operation, user 42 positions the object within field of view 46 of camera 32. An image of the object is displayed upon display screen 40. In one embodiment, user 42 selects the object for tracking via imaging. User 42 may accomplish such selection via input device 36. In another embodiment, the object is selected by the processing system.

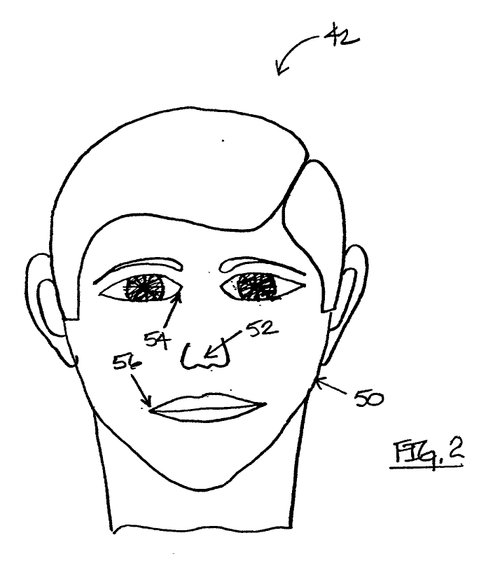

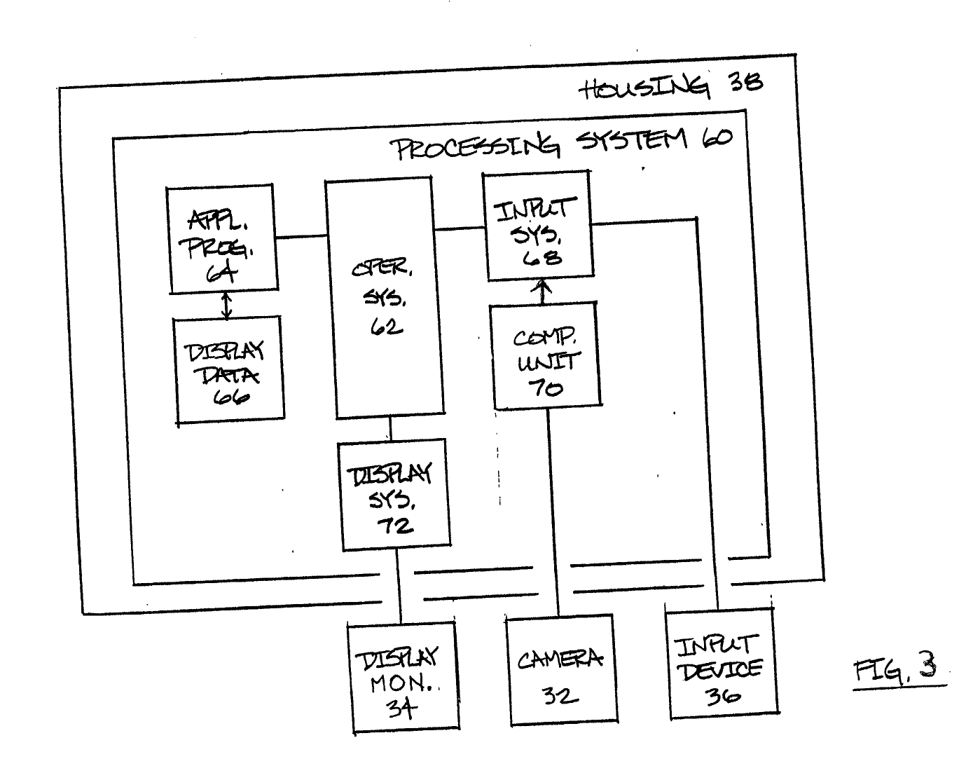

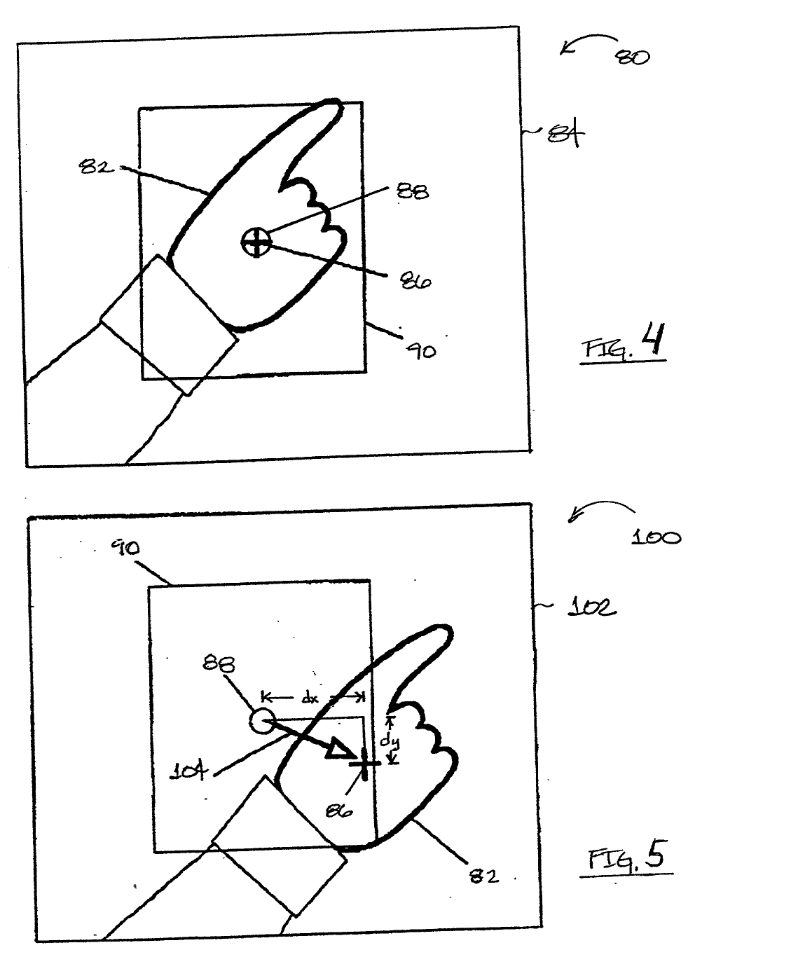

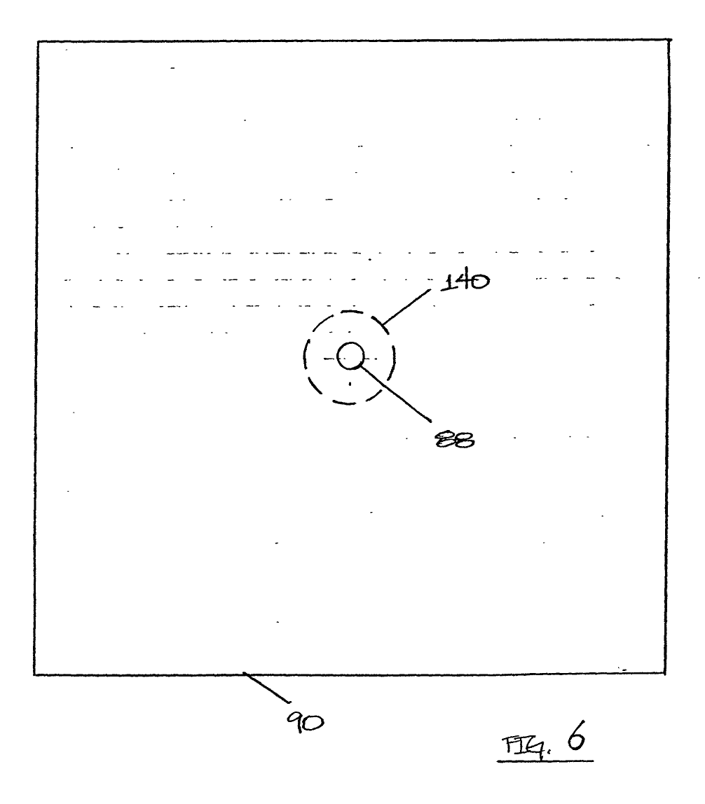

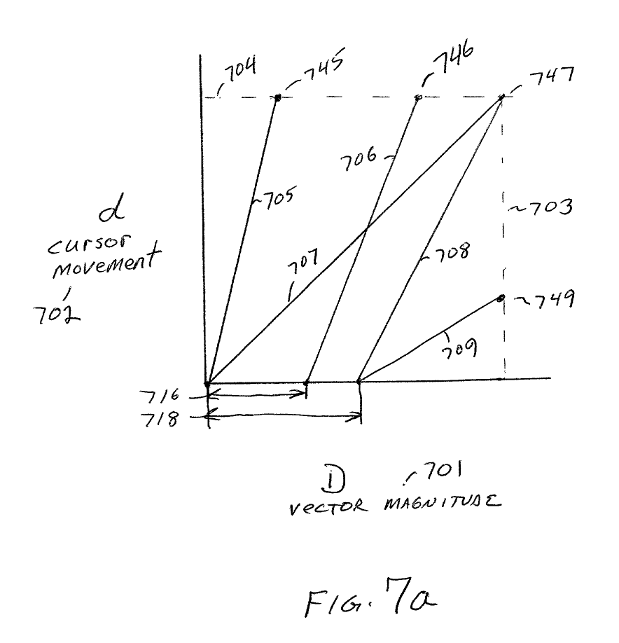

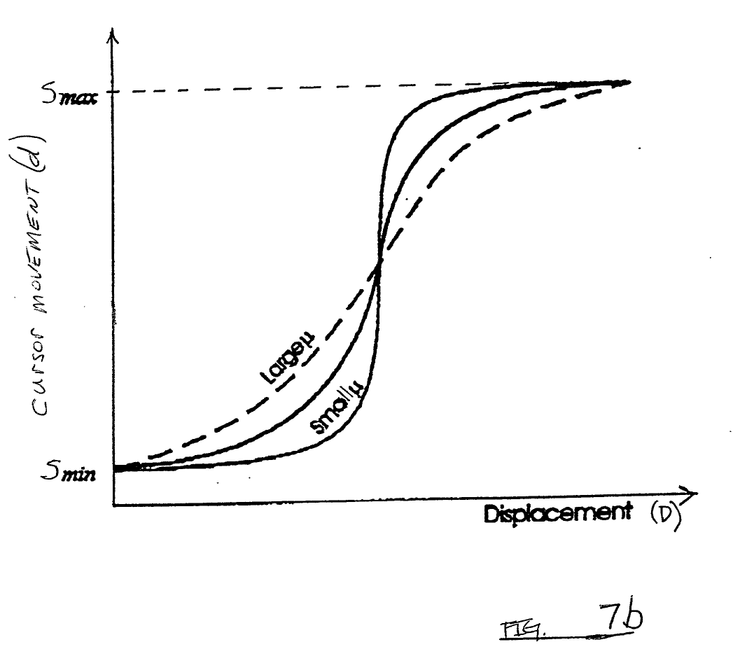

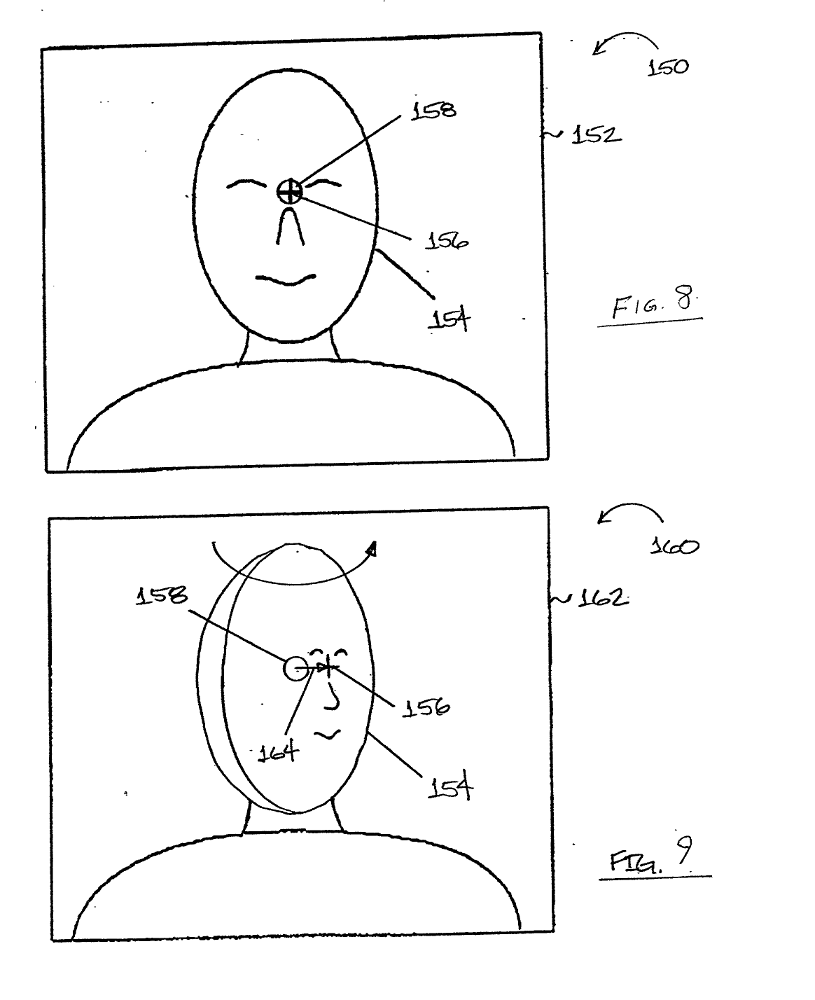

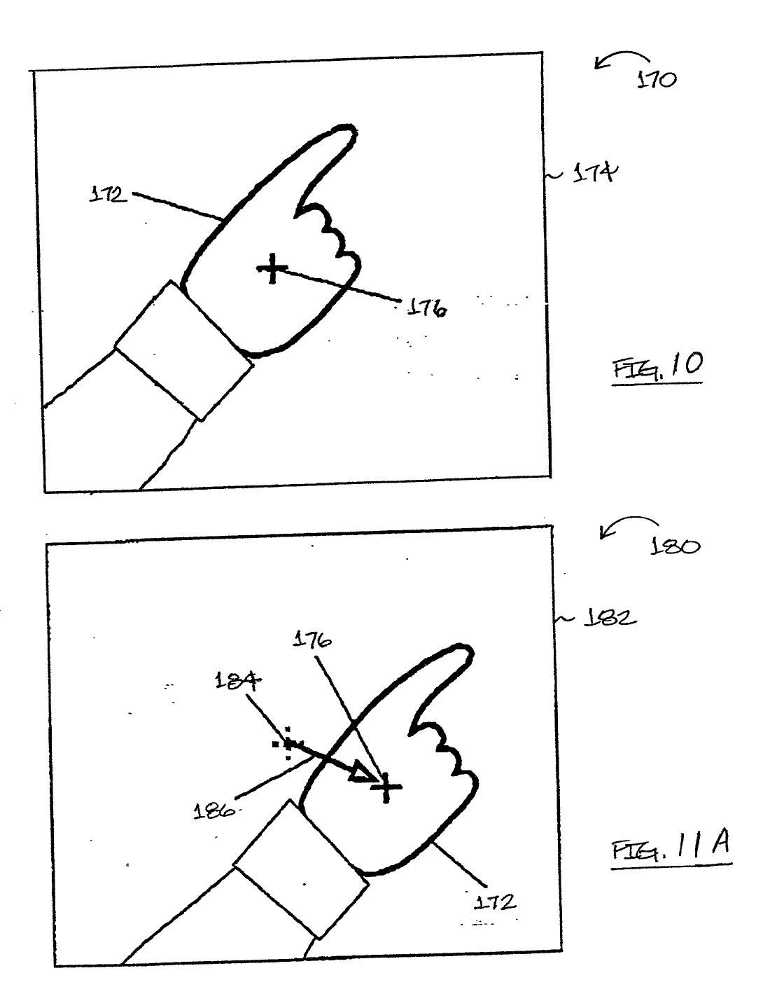

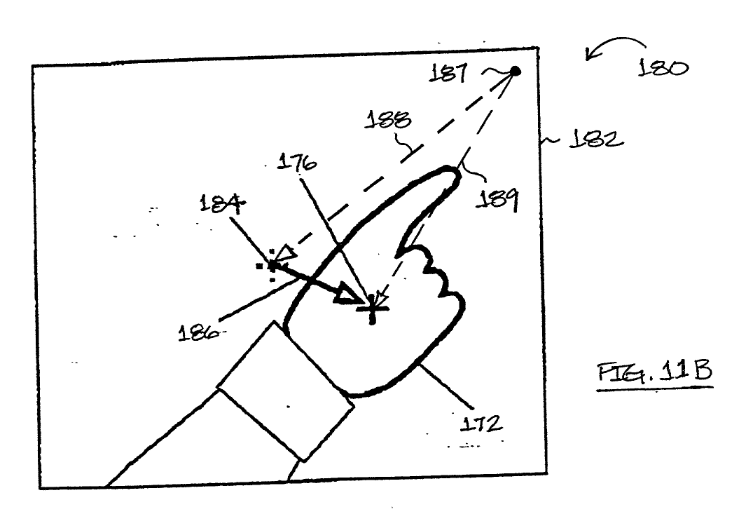

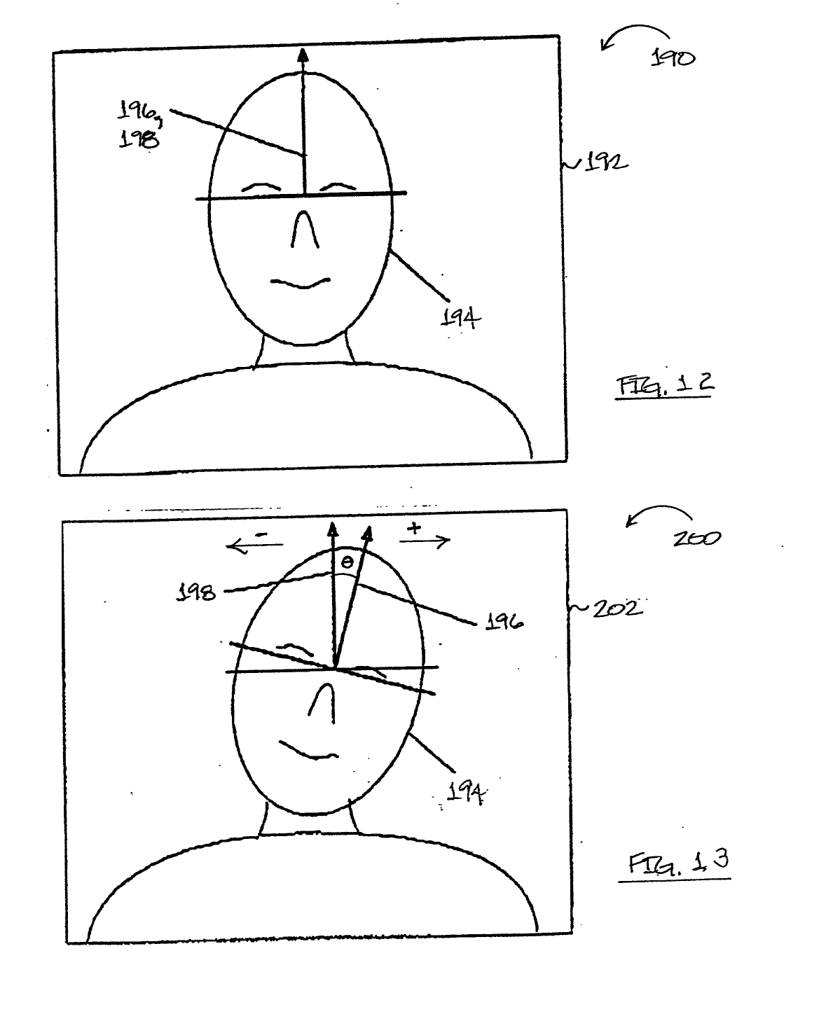

FIG. 2 is front view of the head and neck of user 42 of FIG. 1 illustrating a body part of user 42 and prominent features of the body part which may be tracked by the processing system via imaging. Face 50 of user 42 is a body part of user 42 which is readily identifiable in an image of the head and neck of user 42. Candidate prominent features of face 50, which are also readily identifiable in images of the head and neck of user 42, include nose 52, corner of the eye 54, and corner of the mouth 56.

FIG. 3 is a block diagram of one embodiment of housing 38 of FIG. 1. In the embodiment of FIG. 3, housing 38 houses a processing system 60 coupled to display monitor 34, camera 32, and input device 36. Processing system 60 may be, for example, a computing system including a central processing unit (CPU) coupled to a memory system. The memory system may include semiconductor memory, one or more fixed media disk drives, and/or one or more removable media disk drives. Camera 32 provides electrical image signals to processing system 60.

Processing system 60 uses the image signals produced by camera 32 to determine the state of the selected object, where the state of the selected object may be defined by a position of the selected object, an orientation of the selected object, and/or motion of the selected object. Processing system 60 controls the movement of a cursor on display screen 40 of display monitor 34 dependent upon the state of the selected object.

Processing system 60 may receive user input via input device 36. Input device 36 may be a speech-to text converter, allowing hands free user input. Alternately, input device 36 may be a conventional pointing device such as a mouse, or a computer keyboard.

In the embodiment of FIG. 3, processing system 60 within housing 38 includes an operating system 62 coupled to an application program 64, display data 66, an input system 68, and a display system 72. Operating system 62 and application program 64 include instructions executed by a CPU. Input system 68 includes hardware and/or software (e.g., a driver program) which forms an interface between operating system 62 and either input device 36 or computation unit 70 which receives input from camera 32. Display system 72 includes hardware and/or software (e.g., a driver program) which forms an interface between operating system 62 and display monitor 34. Operating system 62 may receive user input via input device 36 or computation unit 70 from camera 32 and provide the user input to application program 64. Application program 64 produces and/or provides display data 66 to operating system 62 during execution. Operating system 62 translates display data 66 as necessary and provides the resultant translated display data 66 to display system 72. Display system 72 further translates display data 66 as necessary and provides the resultant translated display data 66 to display monitor 34.

Computation unit 70 receives electrical image signals produced by camera 32 and processes the electrical image signals to form images. Camera 32 produces the image signals at regular intervals, and the images produced by computational unit 70 form a series of images ordered chronologically. Computation unit 70 analyzes the images in order to identify the selected object, and to determine the state of the selected object. Computation unit 70 produces an input signal dependent upon the state of the selected object, and provides the input signal to input system 68 and then to operating system 62. Operating system 62 controls the movement of a cursor displayed upon display screen 40 of display monitor 34, and receives input selections at a current cursor location, dependent upon the input signal from computation unit 70.

2D State of a Selected Object

Computer system 30 produces images of the object within image frames. An image of a selected object within an image frame is referred to herein as a “projection” of the selected object. In two-dimensional (2D) embodiments, an image of a selected object within an image frame is a 2D “projection” of the selected object. It may thus be said that a 2D state of a selected object may be defined by a position of the selected object's projection, an orientation of the selected object's projection, and/or motion of the selected object's projection, within an image frame.

2D State Defined by Position Relative to a Base Position

In several contemplated embodiments, the 2D state of the selected object includes a position of the selected object relative to a “base position” of the selected object. As described above, it may also be said that the 2D state of the selected object includes a position of the selected object's projection relative to a base position of the selected object's projection. The base position of the selected object (i.e., the base position of the selected object's projection) may be defined during the calibration procedure.

FIG. 4 is one embodiment of an image 80 of a hand 82 and a portion of a forearm of user 42 of FIG. 1. Hand 82 resides within field of view 46 of camera 32 (FIG. 2), and consequently appears within an image frame 84 of image 80. In FIG. 4, hand 82 is the selected object, and image 80 includes a projection of hand 82. A reference point 86 within a boundary hand 82 (i.e., a boundary of the projection of hand 82) is selected (e.g., by the user during the calibration procedure). The state of hand 82 is defined by the position of reference point 86 relative to a base position 88 of reference point 86. Base position 88 may be defined during the calibration procedure. In FIG. 4, reference point 86 is at base position 88 such that reference point 86 and base position 88 coincide.

In the embodiment of FIG. 4, reference point 86 moves within a full range of motion 90 associated with hand 82 (i.e., projections of hand 82). Base position 88 of reference point 86 exists within full range of motion 90. Full range of motion 90 may be selected automatically by processing system 60, or defined by user 42 during the calibration procedure. It is noted that full range of motion 90 may encompass the entire image 80, and may thus coincide with image frame 84.

FIG. 5 is one embodiment of an image 100 of hand 82 and the portion of the forearm of user 42 of FIG. 4, wherein image 100 is produced within processing system 60 subsequent to image 80 of FIG. 4. Components of image 100 shown in FIG. 4 and described above are labeled similarly in FIG. 5. In FIG. 5, hand 82 appears within an image frame 102 of image 100, thus image 100 includes a projection of hand 82. In FIG. 5, reference point 86 has moved away from base position 88. The position of reference point 86 relative to base position 88 defines a vector 104.

As the state of hand 82 is defined by the position of reference point 86 relative to a base position 88 of reference point 86, the state of hand 82 is defined by vector 104. Vector 104 has a magnitude, representing a distance between reference point 86 and base position 88, and a direction representing a direction of reference point 86 with respect to base position 88.

The direction and magnitude of vector 104 in FIG. 5 may be used to control the repositioning or movement of a cursor displayed upon display screen 40 of display monitor 34. In this situation, processing system 60 may determine the direction and magnitude of vector 104 using images 80 and 100, and provide input to display monitor 34 such that the movement of the cursor occurs in a direction and magnitude corresponding to a direction and magnitude of vector 104. The magnitude of the movement of the cursor may be a linear ratio of the magnitude of vector 104, or may be derived via some other, more complex, mapping function.

The details of the mapping function are determined during a configuration process in which the user may be prompted to move the object to opposite boundaries within a full range of motion, such as full range of motion 90 in FIGS. 4 and 5. The full range of motion of the object may be compared with a known full range of movement of a cursor on a given display connected to the processing system to determine the parameters of the mapping function between an amount of movement of the object and the corresponding amount of movement of the cursor displayed on the display monitor. In other embodiments, the user can directly define the mapping function parameters. In addition, in some embodiments the relationship between the distance in which an object is moved and the distance in which the cursor is moved takes into account an ignored range of movement of the object such as movement that may be caused by uncontrolled shaking of the object by a user.

An “ignored” range of motion may be established about base position 88 such that involuntary movements of hand 82 (FIGS. 5-6) are largely ignored. FIG. 6 is a diagram of one embodiment of full range of motion 90 wherein an ignored range of motion 140 is established about base position 88 such that involuntary movements of hand 82 within ignored range of motion 140 are ignored (i.e., do not result in cursor movement). Components shown in FIGS. 4-5 and described above are labeled similarly in FIG. 6.

Processing system 60 may use one of several mathematical approaches for determining the magnitude of cursor movement with respect to the magnitude of the vector from a base or previous reference point to a subsequent reference point, as illustrated by vector 104 as shown in FIG. 5. FIG. 7a illustrates several exemplary graphical representations of one approach. The “D” axis 701 represents the magnitude of the vector, and the “d” axis 702 represents the resulting cursor movement. A preferred embodiment utilizes a linear relationship between vector magnitude and the magnitude of the cursor movement as illustrated by lines 705, 706, 707, 708, 709. The linearity is expressed as:

d=m(D−I)

where I is the distance of the ignored range of motion and “m” is the ratio factor which determines the slope of a given line. The ratio factor may enable an equal change in cursor movement distance for a given change in object movement distance as shown by line 707. Other ratio factors may enable a large change in cursor movement distance for smaller changes in object distance as shown by line 705. Still yet other ratio factors may enable a relatively smaller change in cursor movement distance for larger changes in object distance as illustrated by line 709. The ratio factor “m” may be based upon the user's preferences or physical limitations. The ratio factor is selectable, such as during the calibration procedure. The selectability of different ratio factors enhances the flexibility of the invention to accommodate differences in physical limitations of various users.

FIG. 7b illustrates another class of functions which can be used to map from D to d. In FIG. 7b, cursor movement d varies over a range extending from dₘᵢₙ to dₘₐₓ. It is noted that dₘᵢₙ may be 0. As reflected in FIG. 7b, cursor movement d is given by:

$$d = \frac{{D}_{max} - {D}_{min}}{1 + {e}^{( \frac{d - k}{μ} )}} + {D}_{min}$$

where variables k and μ have values selected to achieve a desired shape of the curve (i.e., sigmoid) shown in FIG. 7.

Referring to FIG. 5, the magnitude of vector 104 (displacement D) has a component in a horizontal or x direction, Dₓ, and a component in a vertical or y direction, D_{y}. The above function may be applied to the components separately or to the combined vector length.

Referring again to FIG. 5, cursor movement d is preferably approximately equal to dₘᵢₙ when reference point 86 is relatively close to base position 88 (i.e., the magnitude of vector 104, displacement D, is relatively small). Where ignored range of motion 140 (FIG. 11) is established about base position 88, cursor movement d is 0 when reference point 86 is within ignored range of motion 140, and preferably approximately equal to dₘᵢₙ when reference point 86 is at an outer edge of ignored range of motion 140. Cursor movement d is also preferably approximately equal to dₘₐₓ when reference point 86 is close to an outer edge of full range of motion 90. Thus the values of variables k and μ may be selected based upon base position 88, ignored range of motion 140, and/or full range of motion 90. It is noted that the change in cursor movement d with respect to displacement D should be “smooth” such that cursor movement is easily controlled by user 42.

It is noted that other relationships may be employed to obtain cursor movement d from displacement D, including a simple linear or step function relationship between cursor movement and displacement D, or functions more complex than the sigmoid relationship of FIG. 11.

The amount of the “ignored range of motion” is also configurable. In the case of the sigmoid mapping function an ignored range of motion is generally not needed. With other functions, an ignored range of motion can be added. In the case of linear mapping functions, this is shown as 716 for line 706 and 718 for line 708 in FIG. 7a. If the magnitude of the vector is within the ignored range of motion, there is no change in cursor movement, i.e., “d” has the value of zero (0). For example, in this situation, assume the following distances lie along a straight line passing through base position 88 and reference point 86: a distance P between base position 88 and reference point 86, a distance I between base position 88 and an outer edge of ignored range of motion 140, and a distance R between base position 88 and an outer edge of full range of motion 90. In this situation, let displacement D be given by:

$$D = \frac{\vert P - I \vert}{\vert R - I \vert} ,$$

In this form, distance P is compared explicitly to distances I and R, and displacement D only controls cursor movement when reference point 86 is between the outer edges of ignored range of motion 140 and full range of motion 90.

It should be noted that points 745, 746, and 747 in FIG. 7a and point dₘₐₓ in FIG. 7b indicate the maximum amount of possible cursor movement during any one frame time. For example, this may represent the distance from one corner of the display screen to the opposite corner of the display screen. It should also be noted that point 749 is indicative of the distance of a full range of motion of the object. For some types of physical handicaps, the full range of motion may be significantly less than the maximum amount of possible cursor movement. In these situations, a ratio factor such as that used for line 705 in FIG. 7a or a low value of k in FIG. 7b may be most desirable. Otherwise, a repetitive motion of the object can be used in order to continue to advance the movement of the cursor, as more fully explained further below.

It should also be noted that although the above description referred to the magnitude of cursor movement relative to the magnitude of the object displacement vector, the graph of any of the lines of FIG. 7 can be viewed as a graph for the x component of distance. Likewise, a separate but similar calculation can be undertaken to determine the y component of distance. In other words, the magnitude of vector 104 (displacement D) can be treated as two separate components: a component in a horizontal or x direction, dₓ; and a component in a vertical or y direction, d_{y}. Likewise, the magnitude of cursor movement can be treated as separate x and y components.

Although the above described two preferred embodiments wherein there is a linear or sigmoidal relationship between the magnitude of the vector, such as vector 104 of FIG. 5, and the magnitude in a change in cursor movement, other embodiments may utilize other relationships including nonlinear relationships, step function relationships, etc.

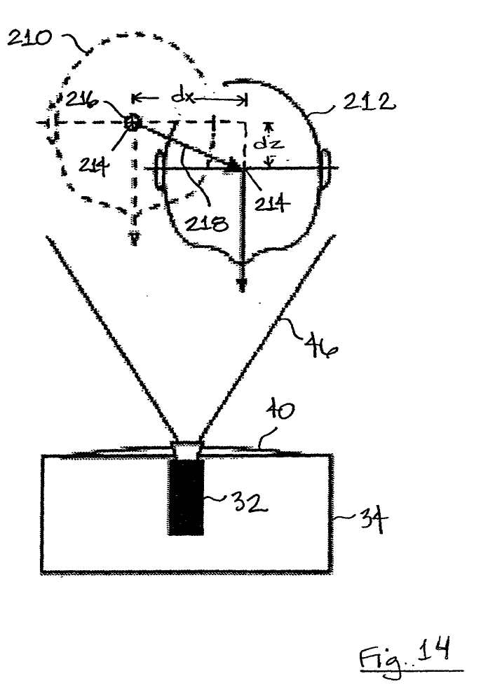

FIGS. 8 and 9 will now be used to illustrate another exemplary use of position of a selected object relative to a base position of the selected object to control cursor movement. FIG. 8 is a diagram of one embodiment of an image 150 of a face, neck, and shoulders of a user (e.g., user 42 of FIG. 2). The face, neck, and shoulders of the user appear within a frame 152 of image 150, thus image 150 includes projections of the face, neck, and shoulders of the user. In FIG. 12, face 154 is the selected object. A center of face 154 is selected as a reference point 156 (e.g., during the calibration procedure). A position of reference point 156 when the user is looking at a center of display screen 40 of display monitor 42 (FIG. 2) is selected as a base position 158 of reference point 156 (e.g., during the calibration procedure). The state of face 154 is defined by the position of reference point 156 (i.e., the center of face 154) relative to base position 158. In FIG. 12, reference point 156 is at base position 158 such that reference point 156 and base position 158 coincide.

FIG. 9 is a diagram of one embodiment of an image 160 of the face 154, neck, and shoulders of the user of FIG. 8. Face 154 and the neck and shoulders of the user appear within a frame 162 of image 160, thus image 160 includes projections of face 154 and the neck and shoulders of the user. Image 160 is produced within processing system 60 subsequent to image 150 of FIG. 8. Components of image 160 shown in FIG. 8 and described above are labeled similarly in FIG. 9. In FIG. 9, face 154 is turned to the user's left. In FIG. 9, reference point 156 has moved to the user's left of base position 88 as the user has rotated or translated his or her head. The position of reference point 156 relative to base position 158 defines a vector 164, and the state of face 154 is defined by vector 164.

The direction of vector 164 may be used to control the cursor movement of display data in the active window displayed upon display screen 40 of display monitor 34. For example, processing system 60 may determine a direction of vector 164 using image 160, and provide the movement of the cursor occurs in a direction corresponding to a direction of vector 164 (e.g., to the user's left). Processing system 60 may also determine a magnitude of vector 164 using image 160, and provide the movement of the cursor such that the distance of the cursor movement is dependent upon the magnitude of vector 164 (e.g., in a manner described above). 10

2D State Defined by Position Relative to a Previous Position

In several contemplated embodiments, the 2D state of the selected object includes a “current” position of the selected object relative to a “previous” position of the selected object. When processing system 60 produces a “current” image, processing system 60 may use the current image to determine the current position of the selected object relative to the previous position of the selected object in a previous image. Thus processing system 60 may determine the 2D state of the selected object by determining the current position of the selected object's projection in the current image relative to the previous position of the selected object's projection in a previous image.

FIG. 11 is a diagram of one embodiment of an image 170 of a hand 172 and a portion of a forearm of a user (e.g., user 42 of FIG. 1). Hand 82 and the portion of the forearm of the user appear within a frame 174 of image 170, thus image 170 includes projections of hand 82 and the portion of the forearm of the user. In FIG. 10, hand 172 is the selected object. A reference point 176 within a boundary of hand 172 is selected (e.g., during the calibration procedure). The state of hand 172 is defined by the position of reference point 176 relative to a position of reference point 176 in a previous image (i.e., a previous position of reference point 176).

FIG. 11A is a diagram of one embodiment of an image 180 of hand 172 and the portion of the forearm of the user of FIG. 10, wherein image 180 is produced within processing system 60 subsequent to image 170 of FIG. 10. Components of image 170 shown in FIG. 10 and described above are labeled similarly in FIG. 11A. In FIG. 11A, hand 172 appears within an image frame 182 of image 180. In FIG. 11A, reference point 176 has moved away from a previous position 184, where previous position 184 is the position of reference point 176 in FIG. 10. The current position of reference point 176 relative to previous position 184 defines a vector 186.

The direction of vector 186 may be used to control cursor movement upon display screen 40 of display monitor 34. For example, processing system 60 may determine a direction of vector 186 using images 170 and 180, and provide the cursor movement such that the cursor movement occurs in a direction corresponding to a direction of vector 186 (e.g., in a manner described above). Processing system 60 may also determine a magnitude of vector 186 using images 170 and 180, and provide cursor movement such that the positioning of the cursor is dependent upon the magnitude of vector 186 (e.g., in a manner described above). The distance of the cursor movement may be a distance in relationship to the distance between the current position of reference point 176 and previous position 184.

FIG. 11B is a diagram of an alternate embodiment of an image 180 of hand 172 and the portion of the forearm of the user of FIG. 10. In the embodiment of FIG. 11B, a second reference point 187 is selected in addition to first reference point 176 (e.g., during the calibration procedure). Second reference point 187 resides within field of view 46 of camera 32 (FIG. 1), and like first reference point 176, second reference point 187 has a projection within images 170 and 180. However, unlike first reference point 176, second reference point 187 is located outside of the boundary of hand 172. Second reference point 187 is a readily identifiable image feature which is stable in two dimensions. Second reference point 187 may be, for example, a corner of an object other than hand 172 residing within field of view 46 of camera 32 (FIG. 1). When processing system 60 produces and analyzes image 170 of FIG. 10, processing system 60 determines a vector 188 extending from second reference point 187 to previous position 184 of first reference point 176 in FIG. 10.

When processing system 60 subsequently produces and analyzes image 180 of FIG. 11B, processing system 60 determines a vector 189 extending from second reference point 187 to the current position of reference point 176. Processing system 60 then determines vector 186 by subtracting vector 188 from vector 189. Processing system 60 may use the direction and magnitude of vector 186 to control the movement of the cursor upon display screen 40 of display monitor 34 as described above.

It is noted that full range of motion 90 (FIGS. 4-5) may also be defined for embodiments where the state of the selected object is a current position of the selected object (i.e., a current position of the selected object's projection) relative to a previous position of the selected object (i.e., a previous position of the selected object's projection). It is also noted that ignored range of motion 140 (FIG. 6) may be defined about reference point 176. For example, once processing system 60 determines the current position of reference point 176, ignored range of motion 140 may be defined around the current position. Subsequent movements of reference point 176 within ignored range of motion 140 surrounding reference point 176 may be ignored. As a result, involuntary movements of hand 172 may be ignored.

It is noted that application of the above approach to a chronological sequence of images results in a chronological sequence of vectors 186. Rather than using vectors 186 to directly control cursor movement as described above, it is also possible to smooth the sequence of vectors 186, or to otherwise derive a description of the motion of the selected object (i.e., the selected object's projection) using the sequence of vectors 186. A resulting motion descriptor may then be used in place of a given vector 186 to control cursor movement.

2D State Defined by Orientation of the Selected Object

In several contemplated embodiments, the 2D state of the selected object includes an “orientation” of the selected object (i.e., the selected object's projection). A “base orientation” of the selected object (i.e., the selected object's projection) may be defined during the calibration procedure.

FIG. 12 is a diagram of one embodiment of an image 190 of a face, neck, and shoulders of a user (e.g., user 42 of FIG. 1). The face, neck, and shoulders of the user appear within a frame 192 of image 190, thus image 190 includes projections of the face, neck, and shoulders of the user. In FIG. 12, face 194 is the selected object. A reference orientation 196 of face 194 is selected (e.g., during the calibration procedure). An orientation of reference orientation 196 is selected as a base orientation 198 of reference orientation 196 (e.g., during the calibration procedure). The state of face 194 is defined by the orientation of reference orientation 196 relative to base orientation 198. In FIG. 12, reference orientation 196 is at base orientation 198 such that reference orientation 196 and base orientation 198 coincide.

FIG. 13 is a diagram of one embodiment of an image 200 of the face 194, the neck, and shoulders of the user of FIG. 12. Face 194 and the neck and shoulders of the user appear within a frame 202 of image 200. Image 200 is produced within processing system 60 subsequent to image 190 of FIG. 16. Components of image 190 shown in FIG. 12 and described above are labeled similarly in FIG. 13. In FIG. 13, face 194 is angled to the user's left. In FIG. 13, reference orientation 196 has rotated to the user's left of base orientation 198 such that an angle θ exists between reference orientation 196 and base orientation 198. The orientation of reference orientation 196 relative to base orientation 198 is defined by angle θ.

The magnitude and sign of angle θ may be used to control the cursor movement upon display screen 40 of display monitor 34. For example, processing system 60 may determine a sign of angle θ using images 190 and 200, and provide the display data to display monitor 34 such that movement of the cursor occurs in a direction corresponding to the sign of angle θ (e.g., to the user's left). Processing system 60 may also determine a magnitude of angle θ using images 190 and 200, and provide cursor movement such that the distance of the cursor movement is dependent upon the magnitude of angle θ, e.g., in a similar manner as described above. When applying the relationship between cursor movement and magnitude of object displacement D described above and reflected in FIG. 7, displacement D may be replaced by the magnitude of angle θ.

It is noted that as the sign of angle θ is either positive (+) or negative (−), cursor movement can only be controlled in two directions based upon the orientation of face 194 (i.e., either left and right or up and down). Cursor movement in other directions may be accomplished by anyone of the following a) determining the sign and magnitude of a second angle t where such an angle is generated by movement of an object or reference point about a different axis or in a second dimension, e.g., such as movement of the head up or down; and b) combining the orientation technique with one of the other cursor movement techniques described above, etc. Detection of other angles my require an additional camera located at a different orientation to the object. For example, an additional camera my be mounted that focuses on the side of the head in addition to the camera that focuses on the front of the face. In this way, angular movement side to side and forward and backward of the head or other object may be depicted.

In alternative embodiments, detection of angular movement triggers a selection signal to be generated at the current cursor location, instead of cursor movement. In this way, the magnitude of a vector which indicates the distance an object or reference point moves is used for determining cursor movement, while any detection of angular movement, outside of any ignored range of movement, is used for determining a selection at the current cursor location.

It is also noted that a full range of motion, similar to full range of motion 90 of FIGS. 5-9, may be defined for reference orientation 196. It is also noted that an ignored range of motion, similar to ignored range of motion 140 of FIG. 10, may be defined about reference orientation 198. Movements of reference orientation 196 within the ignored range of motion surrounding base orientation 198 may be ignored. As a result, involuntary movements of face 194 may be ignored.

3D State of a Selected Object

A three-dimensional (3D) state of a selected object may be determined using a sequence of images produced by computer system 30 of FIG. 1. For example, computer system 30 of FIG. 1 may employ techniques described in “Fast, Reliable Head Tracking Under Varying Illumination: An Approach Based On Registration of Texture-Mapped 3D Models,” by M. LaCascia et al., IEEE Transactions on Pattern Analysis and Machine Intelligence (PAMI), Vol. 22 No. 4, April 2000, to determine the 3D state of a face. The 3D state of the object may also be determined using other systems, e.g. using multiple cameras and techniques described in “Computational Stereo From An IU Perspective,” by S. T. Barnard and M. A. Fischler, Proceedings of the Image Understanding Workshop, 1981, pp. 157-167.

3D State Defined by Position Relative to a Base Position

In several contemplated embodiments, the 3D state of the selected object includes a position of the selected object relative to a “base position” of the selected object. The base position of the selected object may be defined during the calibration procedure.

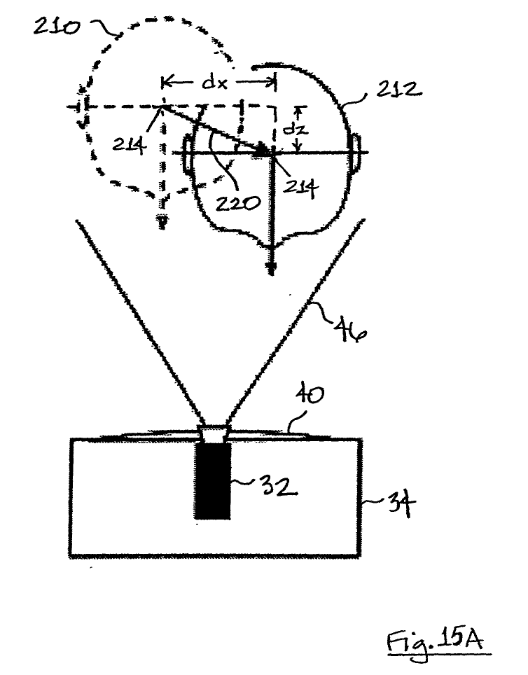

FIG. 14 is a top plan view of a previous position 210 and a current position 212 of the head of user 42 within field of view 46 of camera 32 of the computer system of FIG. 1. In FIG. 14, the head of user 42 is the selected object, and images produced by the computer system include projections of the head of user 42. A reference point 214 within a boundary of the head of user 42 is selected (e.g., by the user during the calibration procedure).

In a first image including previous position 210 of the head of user 42, reference point 214 coincides with a base position 216 of reference point 214. Base position 216 may be established during the calibration procedure. In a second image subsequent to the first image and including current position 212 of the head of user 42, reference point 214 has moved away from base position 216. The state of the head of user 42 is defined by the position of reference point 214 relative to base position 216.

The position of reference point 214 relative to base position 216 defines a vector 218, and the state of the head of user 42 is defined by vector 218. As shown in FIG. 14, vector 218 has a first component dₓ in an x direction and a second component d_{z} in a z direction. Vector 218 also has a third component d_{y} in a y direction (not shown). The dₓ component may be used to control cursor movement in the horizontal x direction, and the d_{y} component may be used to control cursor movement of display data in the vertical y direction. Thus the cursor movement may occur in a direction dependent upon the dₓ and d_{y} components of vector 218.

For example, a full range of motion may be established (e.g., automatically by processing system 60 or by user 42 during the calibration procedure) in a plane passing through base position 216 and substantially parallel to display screen 40 of display monitor 34. The dₓ and d_{y} components of vector 218 are also components of a projection of vector 218 upon the plane including the full range of motion.

A magnitude of vector 218 may be used to control the cursor movement upon display screen 40 of display monitor 34. In this situation, processing system 60 may determine the magnitude of vector 218 using the first and second images, and may provide a magnitude of cursor movement dependent upon the magnitude of vector 218.

Alternately, a magnitude of the projection of vector 218 upon the plane including the full range of motion may be used to make a selection (i.e., a “click”) at the current cursor location. In this situation, processing system 60 may determine the magnitude of the projection of vector 218 upon the plane including the full range of motion, and may provide an indication to processing system 60 that a selection at the current cursor location has been made. More particularly, the d_{z} component of vector 218 may be used to control selection of an item displayed upon display screen 40 of display monitor 34, if, for example, the magnitude of the d_{z} component is greater than a minimum amount, such as an ignored range of motion. As described above, an “ignored” range of motion may be established about base position 216 such that involuntary movements of the head of user 42 are largely ignored. (See FIG. 6.)

3D State Defined by Position Relative to a Previous Position

In several contemplated embodiments, the 3D state of the selected object depends upon a current position of the selected object inferred from a current image relative to a previous position of the selected object inferred from a previous image.

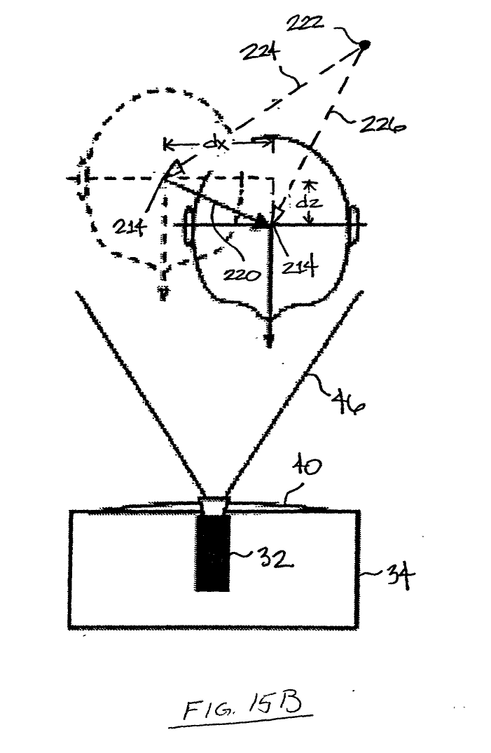

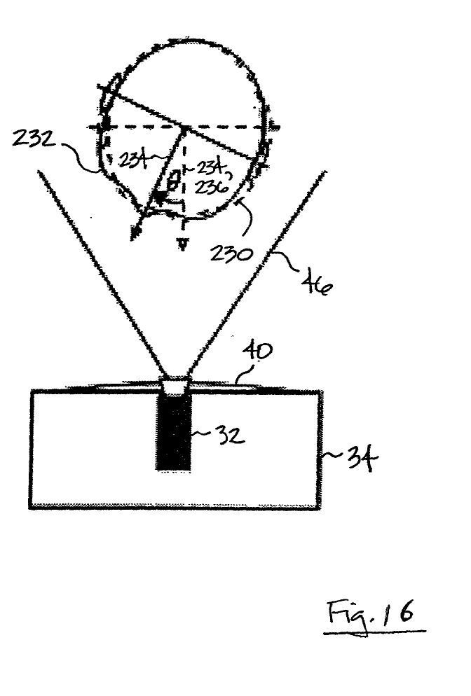

FIG. 15A is a top plan view of previous position 210 and current position 212 of the head of user 42 within field of view 46 of camera 32 of the computer system of FIG. 1. In FIG. 15A, the head of user 42 is the selected object, and images produced by the computer system include the head of user 42. A reference point 214 within a boundary of the head of user 42 is selected (e.g., by the user during the calibration procedure).

From a first image including the projection of the head of user 42 in a previous position 210, reference point 214 was inferred to be in a previous location. From a second image subsequent to the first image and including the projection of the head of user 42 in a current position 212, reference point 214 was inferred to be in a current location which differs from the previous location. The state of the head of user 42 is defined by the current location of reference point 214 relative to the previous location of reference point 214.

The current location of reference point 214 relative to the previous location of reference point 214 defines a vector 220, and the state of the head of user 42 is defined by vector 220. As shown in FIG. 15A, vector 220 has a first component dₓ in the x direction and a second component d_{z} in the z direction. Vector 220 also has a third component d_{y} in the y direction (not shown). The dₓ component may be used to control cursor movement in the horizontal x direction, and the d_{y} component may be used to control cursor movement in the vertical y direction. Thus cursor movement may occur in a direction dependent upon the dₓ and d_{y} components of vector 220.

As described above, a full range of motion may be established (e.g., automatically by processing system 60 or by user 42 during the calibration procedure) in a plane passing through base position 216 and substantially parallel to display screen 40 of display monitor 34. The dₓ and d_{y} components of vector 220 are also components of a projection of vector 220 upon the plane including the full range of motion.

Further still, the d_{z} component of vector 220 may be used to control the selection of an item displayed upon display screen 40 of display monitor 34 at the current cursor location. In this situation, processing system 60 may determine the magnitude of the d_{z} component, and may provide an indication that a selection is being made if the magnitude is greater than a minimum predetermined amount, such as an amount that is indicative of an ignored range of motion.

FIG. 15B will now be used to describe the use of a second reference point within field of view 46 of camera 32 to determine a current location of a first reference point, associated with the selected object, relative to a previous location of the first reference point. FIG. 15B is a top plan view of previous position 210 and current position 212 of the head of user 42 within field of view 46 of camera 32 of the computer system of FIG. 1. In FIG. 15B, a second reference point 222 is selected in addition to first reference point 214 (e.g., during the calibration procedure). Second reference point 222 resides within field of view 46 of camera 32, and images produced by processing system 60 (FIG. 3) include second reference point 222. Unlike first reference point 214, second reference point 222 is located outside of the boundary of the head of user 42. Second reference point 222 is a readily identifiable image feature which is stable in two dimensions. Second reference point 222 may be, for example, a corner of an object other than the head of user 42 residing within field of view 46 of camera 32.

When processing system 60 produces and analyzes the first image including previous position 210 of the head of user 42, processing system 60 determines a vector 224 extending from second reference point 222 to the previous location of first reference point 214. When processing system 60 subsequently produces and analyzes the second image including current position 210 of the head of user 42, processing system 60 determines a vector 226 extending from second reference point 222 to the current location of first reference point 214. Processing system 60 then determines vector 220 by subtracting vector 224 from vector 226. Processing system 60 may determine the dₓ, d_{y}, and d_{z} components of vector 220, and use the components to control input selection and/or cursor movement upon display screen 40 of display monitor 34 as described above.

An ignored range of motion may be defined about reference point 214 as described above. For example, once processing system 60 determines the current position of reference point 176, processing system may define an ignored range of motion around the current position. Subsequent movements of reference point 214 within the ignored range of motion surrounding reference point 214 may be ignored. As a result, involuntary movements of the head of user 42 may be ignored.

It is noted that application of the above approach to a chronological sequence of images results in a chronological sequence of vectors 220. Rather than using vectors 220 to directly control cursor movement as described above, it is also possible to smooth the sequence of vectors 220, or to otherwise derive a description of the motion of the selected object using the sequence of vectors 220. A resulting motion descriptor may then be used in place of a given vector 220 to control cursor movement.

3D State Defined by Orientation of the Selected Object

In several contemplated embodiments, the 3D state of the selected object includes an “orientation” of the selected object. A “base orientation” of the selected object may be defined during the calibration procedure.

FIG. 16 is a top plan view of a previous position 230 and a current position 232 of the head of user 42 within field of view 46 of camera 32 of the computer system of FIG. 1. In FIG. 16, the head of user 42 is the selected object. A reference orientation 234 of the head of user 42 is selected (e.g., during the calibration procedure). An orientation of reference orientation 234 is selected as a base orientation 236 of reference orientation 234 (e.g., during the calibration procedure). The state of the head of user 42 is defined by the orientation of reference orientation 234 relative to base orientation 236.

In a first image including previous position 210 of the head of user 42, reference orientation 234 coincides with base orientation 236. In a second image subsequent to the first image and including current position 212 of the head of user 42, reference orientation 234 has rotated to the user's right of base orientation 236 such that an angle θ exists between reference orientation 234 and base orientation 236. The state of the head of user 42 may be defined by angle θ.

As defined above, the magnitude and sign of angle θ may be used to control the cursor movement upon display screen 40 of display monitor 34. For example, processing system 60 may determine a sign of angle θ using the first and second images, and may provide cursor movement in a direction corresponding to the sign of angle θ (e.g., to the user's right). Processing system 60 may also determine a magnitude of angle θ using the first and second images, and may provide cursor movement dependent upon the magnitude of angle θ (e.g., in a manner described above).

It is noted that angle θ exists in a substantially horizontal plane. A second angle f (not shown) exists between reference orientation 234 and base orientation 236 in a substantially vertical plane. Angle θ changes with rotation of the head of user 42 about the y axis, and angle f changes with rotation of the head of user 42 about the x axis. The sign of angle θ is either positive (+) or negative (−), allowing cursor movement to be controlled in two directions based upon the orientation of the head of user 42 (e.g., left and right). Similarly, the sign of angle f is either positive (+) or negative (−), allowing cursor movement to be controlled in two other directions based upon the orientation of the head of user 42 (e.g., up and down).

Alternately, cursor movement in directions not controlled by angle θ may be accomplished by combining the orientation technique with one of the other cursor movement techniques described above.

In alternative embodiments, detection of angular movement triggers a selection signal to be generated at the current cursor location, instead of cursor movement. In this way, the magnitude of a vector which indicates the distance an object or reference point moves is used for determining cursor movement, while any detection of angular movement, outside of any ignored range of angular movement, is used for determining a selection at the current cursor location.

It is also noted that an ignored range of motion may be defined about base orientation 236. Movements of reference orientation 234 within the ignored range of motion surrounding base orientation 236 may be ignored. As a result, involuntary movements of the head of user 42 may be ignored.

It is also noted that in other embodiments, the 3D state of the head of user 42 may be defined by an orientation of vector 234 with respect to another fixed vector defined within the image (e.g., a vector normal to and extending outward from display screen 40 of display device 34, or normal to and extending outward from opening 44 of camera 32).

The preferred embodiments may be implemented as a method, system, or article of manufacture using standard programming and/or engineering techniques to produce software, firmware, hardware, or any combination thereof. The term “article of manufacture” (or alternatively, “computer program product”) as used herein is intended to encompass data, instructions, program code, and/or one or more computer programs, and/or data files accessible from one or more computer usable devices, carriers, or media. Examples of computer usable mediums include, but are not limited to: nonvolatile, hard-coded type mediums such as CD-ROMs, DVDs, read only memories (ROMs) or erasable, electrically programmable read only memories (EEPROMs), recordable type mediums such as floppy disks, hard disk drives and CD-RW and DVD-RW disks, and transmission type mediums such as digital and analog communication links, or any signal bearing media. As such, the functionality of the above described embodiments of the invention can be implemented in hardware in a computer system and/or in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for use in a CD ROM) or a floppy disk (for eventual use in a floppy disk drive), or downloaded via the Internet or other computer network, as discussed above. The present invention applies equally regardless of the particular type of signal-bearing media utilized.

The foregoing description of the preferred embodiments of the invention has been presented for the purposes of illustration and description. It is not intended to be exhaustive or to limit the invention to the precise form disclosed. Many modification and variations are possible in light of the above teaching.

It is intended that the scope of the invention be limited not by this detailed description, but rather by the claims appended hereto. The above specification, examples and data provide a complete description of the manufacture and use of the system, method, and article of manufacture, i.e., computer program product, of the invention. Since many embodiments of the invention can be made without departing from the spirit and scope of the invention, the invention resides in the claims hereinafter appended.

Numerous variations and modifications will become apparent to those skilled in the art once the above disclosure is fully appreciated. It is intended that the following claims be interpreted to embrace all such variations and modifications.

Having thus described the invention, what we claim as new and desire to secure by Letters Patent is set forth in the following claims.

1. A computer system, comprising:
a display screen;
a camera; and
a processing system coupled between the display screen and the camera, wherein the processing system is adapted to capture successive images of an object, selectable amongst a plurality of objects within a view of the camera, such that changes in a first state of the object as memorialized by the images control movement of a cursor on the display screen according to a configurable relationship between movement of the object and movement of the cursor.

2. The computer system of claim 1 wherein the processing system is further adapted such that changes in a second state of the object control a selection of a selectable item at a current cursor location.

3. The computer system of claim 1 wherein the first state comprises one of a1) movement within a plane defined by a first and second axis, and a2) angular rotation; and
the second state comprises one of b1) movement within a plane defined by a third axis, and b2) a different one of a1) and a2) of the one of the first state.

4. The computer system as recited in claim 1, wherein the processing system is further adapted to receive a selection of at least a portion of said object from among a plurality of objects upon which the camera is directed.

5. The computer system as recited in claim 1, wherein the first state of the object is one of a1) a position of the object, a2) an orientation of the object, and a3) a motion of the object; and the second state of the object is one of b1) a different one of a1), a2), a3); and b2) a different motion of the object.

6. The computer system as recited in claim 1, wherein the object is selected by one of a) automatically by the processing system through a program associated with the processing system, and b) by a user during a calibration procedure.

7. The computer system as recited in claim 1, wherein the object is selected from a group comprising a body part of the user, a prominent feature of portion of the body part, and an object held or worn by the user.

8. The computer system as recited in claim 1, wherein the successive images comprise a first image and a second image of the object, and wherein the first image precedes the second image in time, and wherein a reference point is selected within a boundary of the object, and wherein a previous position of the reference point is determined using the first image, and wherein a current position of the reference point is determined using the second image, and wherein a vector extending from the previous position to the current position defines the first state of the object.

9. The computer system as recited in claim 8, wherein the vector has a dₓ component in an x direction, a d_{y} component in a y direction, and a d_{z} component in a z direction; wherein the x, y, and z directions are orthogonal, and wherein the x and y directions define an xy plane substantially parallel to the display screen of the display device, and wherein the z direction is substantially normal to the display screen of the display device.

10. The computer system as recited in claim 9, wherein the processing system is configured to determine the dₓ and d_{y} components of the vector, and to provide cursor movement such that cursor movement occurs in a direction corresponding to the dₓ and d_{y} components of the vector.

11. The computer system as recited in claim 9, wherein the processing system is configured to determine the d_{z} component of the vector, and to provide a selection of a selectable item at a current cursor location if the d_{z} component is determined to have at least a predetermined minimum magnitude.

12. The computer system of claim 1 wherein the configurable relationship takes into account an ignored range of movement of the object.

13. A computer program, on a computer usable medium having computer readable program code, comprising:
a first set of instructions for instructing a processing system to select from among a plurality of user-controlled objects upon which a camera is directed; and
a second set of instructions which, upon the processing system receiving changes in movement of at least a portion of the selected object as memorialized by said camera, instructs movement of a cursor displayed upon a display screen according to a configurable relationship between object movement and cursor movement.

14. The computer program of claim 13, wherein the changes in movement includes changes in at least one of position, orientation or motion of at least a portion of the object.

15. The computer program of claim 14, wherein an item is selectable at a current cursor location if the changes in movement includes changes in at least a different one of position, orientation or motion.

16. The computer program of claim 13, wherein a portion of the selected object is a programmable selectable point of the selected object.

17. The computer program of claim 13, wherein the second set of instructions comprises first data representing an initial position of the selected object and second data representing a subsequent position of the selected object, and wherein the difference between the first data and the second data causes movement of the cursor on the display in an amount proportional to said difference.

18. The computer program of claim 13 wherein the configurable relationship takes into account an ignored range of movement of the object.

19. A method for causing movement of a cursor on a display screen, comprising:
extracting a reference point of an image captured by a camera, said reference point representing at least a portion of an object that is selected from among a plurality of objects under control of a user;
registering the reference point and subsequent movement of the reference point; and
moving the cursor from a base position based upon the registered movement of the reference point using a configurable relationship between movement of the reference point and movement of the cursor.

20. The method of claim 19 wherein subsequent movement comprises at least one of a1) movement within a plane defined by a first and second axis, and a2) angular rotation.

21. The method of claim 20 further comprising causing a selection of a selectable item at a current cursor location if further subsequent movement comprises one of b1) movement within a plane defined by a third axis, and b2) a different one of a1) and a2).

22. The method of claim 19 wherein the configurable relationship takes into account an ignored range of movement of the object.
